(19) United States
(12) Patent Application Publication
(10) Pub. No.: US 2025/0073002 A1
(43) Pub. Date: Mar. 6, 2025

(54) ABUTMENT ADJUSTING SCREW

(71) Applicant: Daniel Domingue, Lafayette, LA (US)

(72) Inventor: Daniel Domingue, Lafayette, LA (US)

(21) Appl. No.: 18/456,633

(22) Filed: Aug. 28, 2023

Related U.S. Application Data
(63) Continuation-in-part of application No. 29/891,459, filed on May 5, 2023, now Pat. No. D046155.

(51) Int. Cl. A61C 8/00

(52) U.S. Cl. CPC A61C 8/005

(57) ABSTRACT

An axially-extended, dental adjustment abutment screw having a frustoconical cap with a radiused transition from the bottom of the cap to the upper end of the threaded portion. The radiused shape applies pressure axially in an apical direction when tightened to adjust the height of the prosthetic. The cap also has a centrally-located recess with a multilobed recess that allows secure gripping by an insertion tool for installation in an abutment base at angles within the range of 0-25 degrees.

### FIELD OF THE INVENTION

The invention relates to screws used for arch restoration in dentistry.

### BACKGROUND OF THE INVENTION

Restorative dentistry uses a prosthetic mounted to dental superstructure to repair or create both esthetic and functional operation of the jawline arch of a patient. In multi-element superstructures, the prosthetic is connected to an abutment which is secured to an implant in the bone. The implant acts as the root of the tooth. After an appropriate period of time for the bone to grow into the implant, the prosthetic can be attached to the implant. The abutment serves the biomechanical and esthetic purposes of compensating for the angular difference between the axis of the implant and the occlusal direction. This angular compensation ensures that the forces of the jaw are properly transferred to the implant.

The abutment has two sides that perform different functions. On the bottom side that is oriented toward the jaw, the abutment must provide the attachment of the abutment structure to the implant in the jaw. On the top side that is oriented toward the oral cavity, the abutment provides a structure to which conventional prosthetics can be fitted. The top side of the abutment typically has some type of post-like appearance. The post follows the axis of the tooth to be replaced. The post axis is perpendicular to the occlusal surface of the teeth, especially in the case of molars. Methods for designing such abutment structures is described in U.S. Pat. No. 7,901,209 the disclosure of which is hereby incorporated by reference.

Examples of commercially available abutment products include the multi-unit abutment, a metal bar substructure (e.g., titanium or chromium cobalt), and a frustoconical titanium base. All of these use a threaded screw to connect the prosthetic to the abutment. Conventional abutment screw measures 2 mm in diameter, 7.8 mm in length, and 0.4 mm in screw thread pitch. This is a height to diameter ratio of 3.9.

Screws of various configurations have been proposed to connect the prosthetic implant to the abutment. One currently available, adjustment screw uses a substantially square top cap with a sidewall that is parallel to the axial advancement direction (i.e., the apical direction) of the screw. When axial adjustment force is exerted on the interior channel walls of a prosthetic to be retained, the point force from the square edge of the adjustment screw cap on the contact point of the prosthetic can exceed the fracture strength of the prosthetic. The result is often a cracked or broken prosthetic.

In another example, Published US Application 2008/0057473 describes a dental implant assembly having a threaded adjustment screw with a frustoconical head that corresponds to a frustoconically-shaped channel within a prosthetic. The frustoconical shape of the adjustment cap engages the inner walls of the channel and exerts both apical and lateral force within the prosthetic.

It would be desirable to have an adjustment screw for dental prosthetics that would exert well-distributed advancement forces on the interior channel of the prosthetic.

The shape and configuration of dental adjustment screws can be compromised by the need to insert the screw down an angled channel in the prosthetic before contact with the abutment. Channel angles of up to 15-25 degrees are not unusual. Such angles dictate a maximum diameter and shape for the cap head of the screw.

It would be desirable to have a dental adjustment screw that could be successfully into an interior channel of a prosthetic to be retained that was angled up to 25 degrees from vertical.

### SUMMARY OF THE INVENTION

It is an object of the invention to provide a dental abutment adjustment screw that was shaped and configured to exert uniform apical advancement force below a fracture threshold of the prosthetic along and within a screw insertion channel formed in the prosthetic.

It is also an object of the invention to provide a dental abutment adjustment screw that can be inserted into a prosthetic channel of up to about 25 degrees from vertical.

In accordance with these and other objectives of the invention that will become apparent from the description herein, a dental abutment adjustment screw according to the invention is made from a medically-acceptable material and includes: (a) a bottom portion having a bottom profile at a bottom end of said bottom portion, (b) a threaded middle portion extending helically in said axial direction from said bottom portion to an upper location of said middle portion, and (c) a top portion which comprises: (i) a frustoconical cap having a tapered external wall that is larger in diameter at a top end of said cap than at a bottom of said cap. (ii) an open recess that is centrally located in said cap and within said external wall, said recess exhibiting a plurality of arc-shaped recess lobes that are spaced equidistant around a perimeter of said recess and which extend radially from said axis, and (iii) a radiused transition from said cap to said upper location of said middle portion that exerts force in an axial, apical direction when tightened against an interior retention channel of a dental prosthetic having a corresponding, mating radiused transition.

The dental abutment adjustment screw of the present invention provides advantages not found in prior art adjustment screws. More specifically, the adjustment screw of the present invention can be used with multi-unit, titanium or chromium-cobalt substructure bars, and frustoconical abutment bases as well as allow installation in prosthetic channels of up to about 25 degrees from vertical. The screw, as well as the installation tool, can also be designed with a breakaway force that is less than the fracture force of the prosthetic material. A method for securing a dental prosthetic to a base by a process that comprises: passing the adjustment screw of the present invention through an opening in said dental prosthetic (a) directly to a multi-unit abutment base, (b) through a metal substructure made from titanium or chromium-cobalt, or (c) into a titanium base. The opening can be vertical (coronal) or angled relative to vertical (coronal) within a range from about 0-25 degrees, preferably within the range of about 5-20 degrees and all angles therebetween.

The unique configuration of the present adjustment screw affords practitioners with greater flexibility than was hitherto available with prior art adjustment screws for dental prosthetics.

### BRIEF DESCRIPTION OF THE DRAWINGS

FIG. 1 is a top isometric view of an adjustment screw according to the invention.

FIG. 2 is a top view showing a hexalobe engagement recesses in the recess of the screw cap.

FIG. 3 is an external, side view of an adjustment screw according to the invention.

FIG. 4 is a sectional view of the adjustment screw shown in FIG. 3.

FIG. 5 shows the adjustment screw of the invention secured within the installation channel of a prosthetic and an abutment.

FIG. 6 depicts the placement of the adjustment screw of the invention down an angled installation channel.

FIG. 7 illustrates an insertion tool that breaks when a predetermined torque force is exceeded.

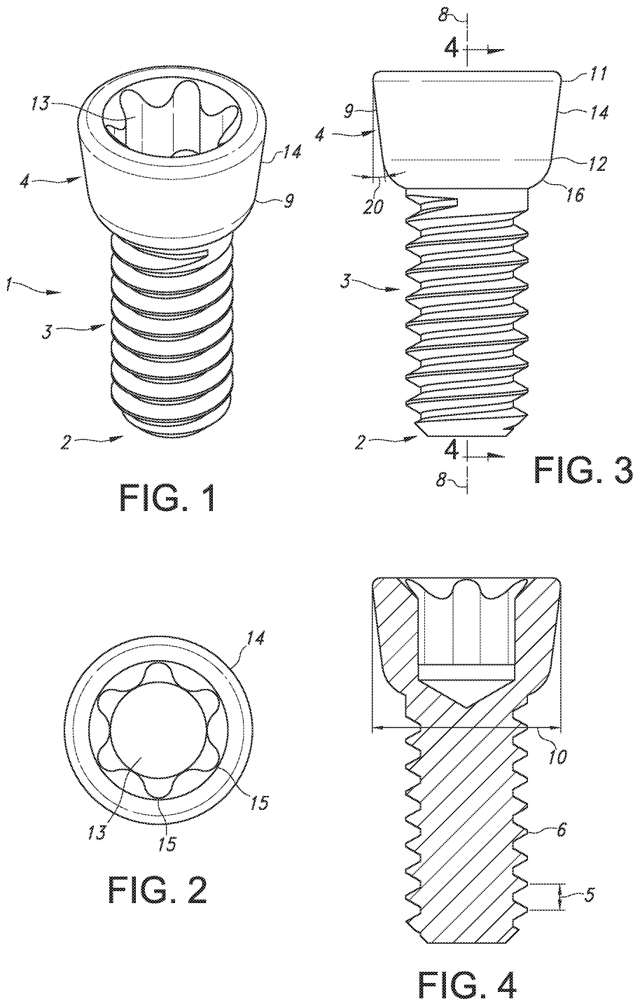

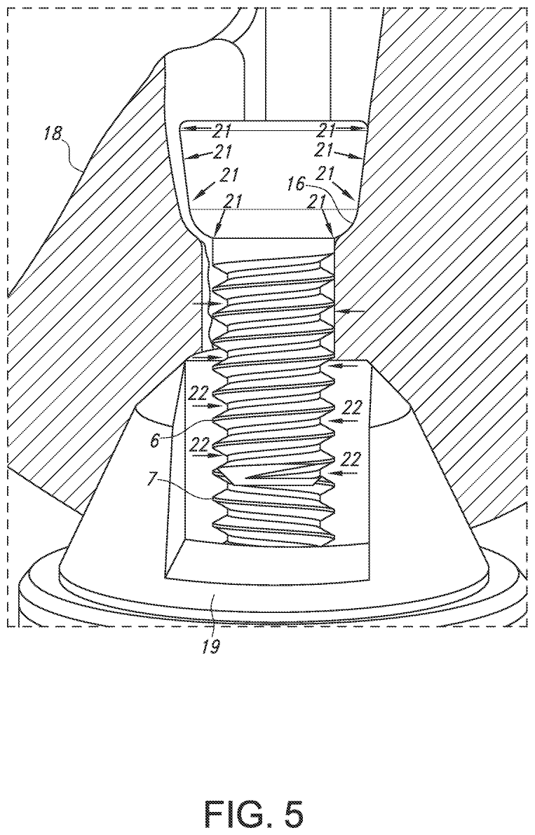

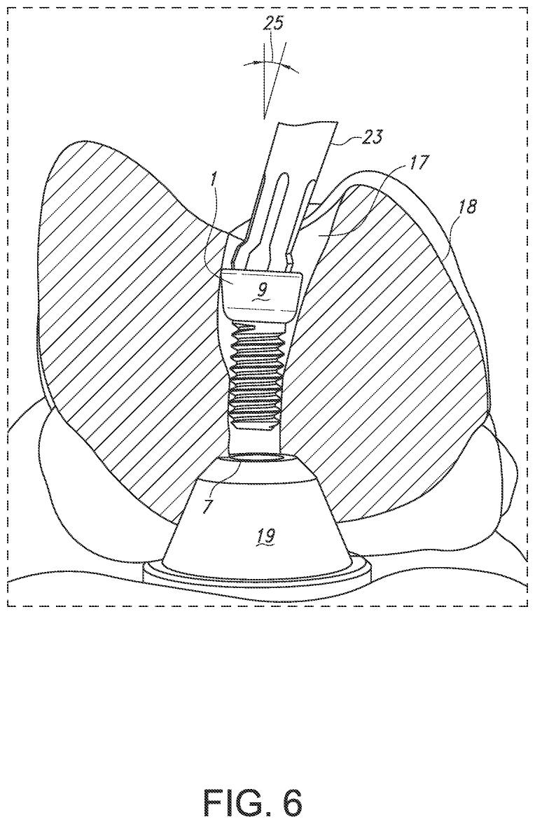

### DETAILED DESCRIPTION OF THE INVENTION

The present invention is an abutment adjusting screw that provides a number of desirable features to ease the installation of a dental prosthetic and its continued use.

The adjusting screw of the present invention is unlike a conventional screw or bolt that might be available in the local hardware store. For example, the adjusting screw is made from a medical grade material suitable for the application of a torque force to advance the screw into engagement with a prosthetic abutment, which is also made of a medical grade material such as titanium.

Titanium has the ability to fuse together with living bone in a process called “osseointegration.” This property makes it a huge benefit in the world of dentistry which explains why titanium dental implants have become the most widely accepted and successfully used type of implant. When bone-forming cells attach themselves to the titanium implant, a structural and functional bridge forms between the body's bone and the newly implanted, foreign object.

Of particular interests are titanium alloys. The main alloy used is so-called commercially pure titanium, cpTi. This metal is available in four grades numbered 1 to 4, according to the purity and the processing oxygen content. These grades differ in corrosion resistance, ductility and strength. Grade 4 cp-Ti has the highest oxygen content (around 0.4%) and best overall mechanical strength so it is most widely used for dental implants.

Titanium 6AL4V (grade 5 titanium) and 6AL4V ELI are alloys containing 6% aluminum and 4% vanadium. They are two of the most common types of titanium used in medicine and offer greater fracture-resistance when used in dental implants. Also known as Gr. 5 and Gr. 23, these are some of the most familiar and readily available types of titanium in the United States. See Table 1.

TABLE 1
Composition and properties of titanium alloys used as implants.

| | cpTi | cpTi | cpTi | cpTi | |
|---|---|---|---|---|---|
| | Grade 1 | Grade 2 | Grade 3 | Grade 4 | Ti6Al4V |
| Titanium | ca 99% | ca 99% | ca 99% | ca 99% | 90% |
| Oxygen | 0.18% | 0.25% | 0.35% | 0.4% | 0.2% |
| | | | | | max |
| Iron | 0.2% | 0.2% | 0.2% | 0.3% | 0.25% |
| Nitrogen | 0.03% | 0.03% | 0.05% | 0.05% | — |
| Hydrogen | 0.15% | 0.15% | 0.15% | 0.15% | — |
| Carbon | 0.1% | 0.1% | 0.1% | 0.1% | — |
| UTS/MPa | 240 | 340 | 450 | 550 | 900 |
| Yield | | | | | |
| strength/MPa | 170 | 275 | 380 | 480 | 850 |
| Elongation at | 25 | 20 | 18 | 15 | 10 |
| failure/% | | | | | |

The adjusting screw of the present invention also provides a tapered top cap and a radiused bottom shoulder that are configured to engage the geometry of the prosthetic installation channel in a way that the downward axial (i.e., apical) forces needed to secure the prosthetic to the abutment at a desired position are evenly distributed within the prosthetic channel. This represents an improvement over prior art adjusting screws that provided either no bottom shoulder radius or presented one that was too small which created unacceptable point forces that exceeded the yield strength of the prosthetic material at the point of contact and associated damage to the prosthetic.

The tapered cap preferably has a taper ratio of the maximum diameter at the top of the cap to the diameter at the bottom of the cap portion above the shoulder that is within the range from about 1.4 to about 1.8, preferably a range from about 1.5 to about 1.7, and most preferably a ratio of about 1.55-1.65. A ratio of about 1.6 is especially preferred.

The tapered cap alone helps with insertion into an angled prosthetic channel. For instance, a screw having a small cap but a long length would likely not fit within an angled prosthetic channel due to the length of the screw engaging the channel walls before completing the turn into the prosthetic channel. The head would also be likely to have enough diameter to distribute the installation torque forces adequately to avoid damage to the prosthetic. Similarly, a large cap with a short length would pose the same insertion problems due to interference between the outer walls of the cap and the angles involved with the prosthetic channel.

Angled installation channels in a prosthetic can be needed to accommodate the angle of the implant in the jawbone and/or the desired angle of the prosthetic in the restoration. With the installation screw of the present invention, suitable prosthetic channels can exhibit an angle from the vertical (or coronal direction) that is within a range from about 0-25 degrees, 5-20 degrees, and preferably channel angles of 5, 10, 15, 20, and 25 degrees with any whole or fractional angle therebetween.

The installation process with the screw of the present invention is made easier when the tapered cap is combined with a suitable overall screw height such that the height to maximum cap diameter ratio (H:D) is with the range from about 1 to about 3. Most preferably, the H:D ratio is within the range of 1.5-2.5 and even more preferably within the range of 1.9-2.3.

The cap of the present screw has a recess opening with lateral recess extensions in the form of arc-shaped lobes that provide engagement surfaces for the lobe-shaped extensions of an installation tool. Preferably, the recess has 4-8 lobes although the use of six lobes (hexalobe or 6lobe) is preferred. The use of engaging, multiple lobes allows the installation tool some degree of latitude with continuing to engage and advance the adjusting screw even while tilted away from the vertical axis of screw advancement. This is an advantage that cooperates with the other structures of the adjusting screw of the present invention.

Turning now to the figures, adjustment screw 1 has a bottom portion 2, a threaded middle portion 3, and a top portion 4. The pitch 5 of screw threads 6 in middle portion 4 are chosen to engage with corresponding abutment threads 7 and extend helically along extended screw axis 8.

Top portion 4 includes a frustoconical cap 9 that has a tapering diameter 10 at angle 20 in which diameter 10 is greater at the top 11 of cap 9 than towards the bottom 12 of cap 9. As illustrated, the H:D ratio of the preferred screw illustrated is about 2.1.

Within cap 9 is recess 13 that is centrally located in cap 9 and within the external wall 14 defined by diameter 10. Recess 13 is a cavity that exhibits a plurality of arc-shaped lobes 15 that are spaced equidistant around the perimeter of recess 13 and which extend radially away from screw axis 8. Preferably, recess 13 has 4-8 lobes 15 although the use of six lobes (hexalobe or 6lobe) is preferred.

Bottom 12 of cap 9 exhibits a radiused external transition shoulder 16 from bottom 12 to middle portion 3. A suitable range of radius of curvature for shoulder 16 is 0.38 mm to 0.44 mm and within the angulation of sixty-six degrees being preferred.

The combination of the rounded profile of shoulder 16 and the taper of diameter 10 at angle 20 work in concert within a tapered channel 17 to exert force in an axial, apical direction when screw 1 is tightened within channel 17 of dental prosthetic 18. Preferably, channel 17 is formed with a corresponding taper and radiused bottom transition to snugly receive screw 1 and act against the exterior the taper of diameter 10 and radiused shoulder 17 of screw 1 when screw 1 is fully installed within channel 17. Uniform force 21 can then be applied within channel 17 to move prosthetic 18 axially downward in an apical direction. Having an axially extended length of screw 1 advanced into abutment 19 also provides additional lateral support 22 against lateral tilting and rotation by the interaction between screw threads 6 and abutment threads 7 as well as the apical force of prosthetic 18 against abutment 19.

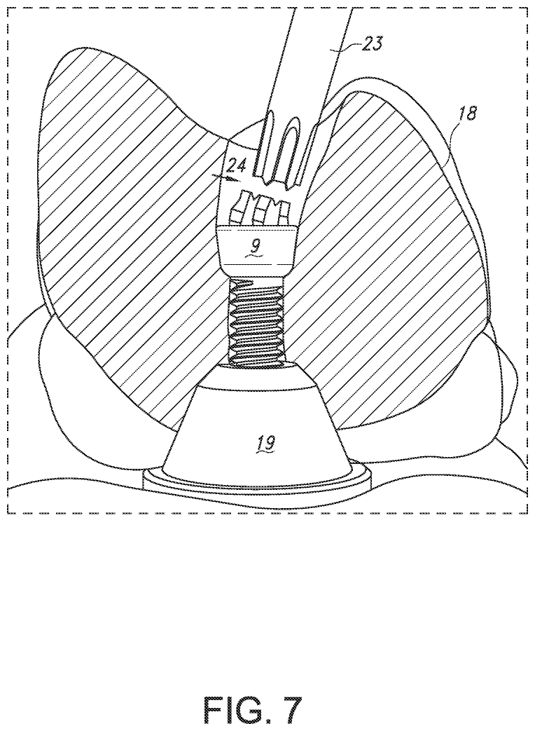

As shown in FIG. 6, the tapered shape of cap 9 and use of a multilobed recess 13 allow installation tool 23 to install screw 1 into an angled channel 17 in prosthetic 18 and then into engagement with abutment threads 7 of abutment 19. Shoulder 16 then engages the interior wall of channel 19 and advances prosthetic 19 axially downward in an apical direction until prosthetic 18 is at the desired position. With the installation screw of the present invention, channel 17 can exhibit a channel angle 25 from vertical that is within a range from about 0-25 degrees, such as channel angles of 5, 10, 15, 20, and 25 degrees with any whole or fractional angle therebetween.

As shown in FIG. 7, installation tool 23 can be designed with a shear line 24 so that the head of tool 23 shears if a predetermined torque force is applied. The specific shearing force desired can be determined in advance of use based on several factors that include: (a) the material of the prosthetic and its compression and expansion fracture limits, (b) the curvature radius of shoulder 16, and (c) the material used in tool 23. Suitable shearing line torque limits are generally within the range of 10-35 Ncm. The selection of components suitable to secure prosthetic 18 without fracture by screw during installation and use is well within the existing and expected level of skill for one having no more than an ordinary level of skill in the art of dental restoration.

What is claimed is:

1. A dental abutment adjustment screw configured to secure a dental prosthetic to a dental abutment, said dental screw extending apically in an axial direction and being made from a medically-acceptable material, said screw comprising:
a. a bottom portion having a bottom profile at a bottom end of said bottom portion,
b. a threaded middle portion extending helically in said axial direction from said bottom portion to an upper location of said middle portion,
c. a top portion which comprises:
(i) a frustoconical cap having a tapered external wall that is larger in diameter at a top end of said cap than at a bottom of said cap,
(ii) an open recess that is centrally located in said cap and within said external wall, said recess exhibiting a plurality of arc-shaped recess lobes that are spaced equidistant around a perimeter of said recess and which extend radially from said axis, and
(iii) a radiused external transition shoulder from said cap to said upper location of said middle portion that exerts force in an axial, apical direction when tightened against an interior retention channel of a dental prosthetic having a corresponding, mating radiused transition.

2. A dental abutment adjustment screw as in claim 1 wherein the tapered external wall of said frustoconical cap tapers has a maximum diameter at the top of said cap and a smaller diameter at the bottom of said cap above said shoulder in a taper ratio within a range from about 1.5 to about 1.7.

3. A dental abutment adjustment screw as in claim 2 wherein said taper ratio is within a range from about 1.55 to 1.65.

4. A dental abutment adjustment screw as in claim 1 wherein said screw exhibits an overall screw height to maximum cap diameter ratio that is with a range from about 1 to about 3.

5. A dental abutment adjustment screw as in claim 4 wherein said screw exhibits an overall screw height to maximum cap diameter ratio that is with a range from about 1.5 to about 2.5.

6. A dental abutment adjustment screw as in claim 5 wherein said screw exhibits an overall screw height to maximum cap diameter ratio that is with a range from about 1.9-2.3.

7. In combination, (a) a dental adjustment abutment configures to connect on a first end to an implant in a patient's jawbone and on a second end to receive a dental screw, and (b) a dental screw made from a medical-grade metal and comprising:
a. a bottom portion having a bottom profile at a bottom end of said bottom portion,
b. a threaded middle portion extending helically in said axial direction from said bottom portion to an upper location of said middle portion,
c. a top portion which comprises:
(i) a frustoconical cap having a tapered external wall that is larger in diameter at a top end of said cap than at a bottom of said cap,
(ii) an open recess that is centrally located in said cap and within said external wall, said recess exhibiting a plurality of arc-shaped recess lobes that are spaced equidistant around a perimeter of said recess and which extend radially from said axis, and
(iii) a radiused transition from said cap to said upper location of said middle portion that exerts force in an apical direction when tightened against an interior retention channel of a dental prosthetic having a corresponding, mating radiused transition.

8. A combination as in claim 7 further comprising a dental prosthetic having an installation channel that exhibits an angle within a range from about 0 to about 25 degrees from vertical.

9. A dental abutment adjustment screw as in claim 7 wherein the tapered external wall of said frustoconical cap tapers has a maximum diameter at the top of said cap and a smaller diameter at the bottom of said cap above said shoulder in a taper ratio within a range from about 1.5 to about 1.7.

10. A dental abutment adjustment screw as in claim 9 wherein said taper ratio is within a range from about 1.55 to 1.65.

11. A dental abutment adjustment screw as in claim 7 wherein said screw exhibits an overall screw height to maximum cap diameter ratio that is with a range from about 1 to about 3.

12. A dental abutment adjustment screw as in claim 11 wherein said screw exhibits an overall screw height to maximum cap diameter ratio that is with a range from about 1.5 to about 2.5.

13. A dental abutment adjustment screw as in claim 12 wherein said screw exhibits an overall screw height to maximum cap diameter ratio that is with a range from about 1.9-2.3.

14. A method for securing a dental prosthetic to a base by a process that comprises: passing an adjustment screw through an opening in said dental prosthetic (a) directly to a multi-unit abutment base, (b) through a metal substructure made from titanium or chromium-cobalt, or (c) into a titanium base,
wherein a dental screw made from a medical-grade metal and comprising:
a bottom portion having a bottom profile at a bottom end of said bottom portion, a threaded middle portion extending helically in said axial direction from said bottom portion to an upper location of said middle portion,
a top portion which comprises:
a frustoconical cap having a tapered external wall that is larger in diameter at a top end of said cap than at a bottom of said cap,
an open recess that is centrally located in said cap and within said external wall, said recess exhibiting a plurality of arc-shaped recess lobes that are spaced equidistant around a perimeter of said recess and which extend radially from said axis, and
a radiused transition from said cap to said upper location of said middle portion that exerts force in an apical direction when tightened against an interior retention channel of a dental prosthetic having a corresponding, mating radiused transition.

15. A method as in claim 14 wherein said opening in said dental prosthetic exhibits an angle within a range from about 5-20 degrees from coronal direction.
